(19) United States
(12) Patent Application Publication
(10) Pub. No.: US 2015/0240433 A1
(43) Pub. Date: Aug. 27, 2015

(54) APPARATUS FOR COLLECTING ANIMAL FECES

(71) Applicant: Ellen Sorbello, North Wales, PA (US)

(72) Inventor: Ellen Sorbello, North Wales, PA (US)

(21) Appl. No.: 14/709,749

(22) Filed: May 12, 2015

(51) Int. Cl. E01H 1/00; A01K 1/01; E01H 1/08

(52) U.S. Cl. CPC E01H 1/006; E01H 1/008; E01H 1/0836; A01K 1/01

(57) ABSTRACT

An apparatus for collecting animal feces from a select surface, is discloses. The apparatus includes a sensor module for detecting the presence of animal feces on the select surface. A collector collects the animal feces. The collector comprises a tube having a suction mount for sucking the animal feces rearwardly into the tube. The apparatus further comprises a waste capture canister configured to the tube via an L-shaped bracket, the waste capture canister configured to collect and store the animal feces sucked rearwardly into the tube. The apparatus also includes a second canister for storing a freezing agent for solidifying the animal feces. The apparatus further includes a camera module configured to capture images of animal feces on the select surface, and a display module communicably coupled to the camera module for displaying the images captured by the camera module.

### CROSS REFERENCE TO RELATED APPLICATION

The present application claims priority of provisional application No. 62/107,318, filed Jan. 23, 2015.

### BACKGROUND

1. Technical Field

The present disclosure relates to waste collection and disposal systems. More particularly, the present disclosure relates to an apparatus designed to hygienically collect and dispose animal feces.

2. Description of Related Art

In today's modern world, a majority of the population lives in urban localities, and most of the population have pets. It is imperative that the feces discharged by the pets are collected and disposed appropriately, for hygiene and health related reasons. Many cities have laws mandating the pet owners pick up the feces discharged by their pets while they are being walked.

The prior art in the field enables manual collection and disposal of animal feces. However, the apparatus envisaged by the present disclosure attempts to automate the process of collection and disposal of animal feces. The prior art available in the field does not describe an apparatus that automatically senses the presence of animal feces, and subsequently, automatically collects (pick up) the animal feces. Therefore, there was felt a need for an apparatus that has been configured to automatically detect and collect animal feces.

### OBJECTS

An object of the present disclosure is to provide an apparatus that allows animal feces to be collected and disposed in a hygienic manner.

Yet another object of the present disclosure is to provide an apparatus that is easy to use and easy to maintain.

Still a further object of the present disclosure is to provide an apparatus that automatically collects animal feces without manual intervention.

One more object of the present disclosure is to provide an apparatus that is capable of fast freezing wet feces, for easy disposal.

Yet another object of the present disclosure is to provide animal feces collecting apparatus that is easy to clean.

### SUMMARY

The present disclosure envisages an apparatus for collecting animal feces from a select surface. The apparatus comprises at least one sensor module configured to detect the presence of animal feces on the select surface.

The apparatus, in accordance with the present disclosure further includes a collector configured to collect the animal feces, the collector comprising a tube having a suction mount attached thereto, the suction mount operable via a gas powered engine, the suction mount configured to suck the animal feces rearwardly into the tube.

The apparatus in accordance with the present disclosure further comprises a waste capture canister connected to the tube via an L-shaped bracket, the waste capture canister configured to collect and store the animal feces sucked rearwardly into the tube.

The apparatus further includes a second canister configured to store a freezing agent for solidifying the animal feces.

The apparatus further includes a camera module configured to capture images of animal feces on the select surface, the apparatus further comprising a display module communicably coupled to the camera module for displaying the images captured by the camera module.

The apparatus further includes a forward drive lever coupled to the gas powered engine, the forward drive lever configured to enable the apparatus to be pushed in a forward direction.

The apparatus further includes a C-clamp having a plurality of grooves, the C-clamp configured to secure the waste capture canister to the tube.

The apparatus in accordance with the present disclosure, wherein the tube includes a centrally disposed longitudinal axis, a proximal end and a distal end, wherein the proximal end is connected to the suction mount and the distal end is connected to the waste capture canister.

The present disclosure envisages a method for collecting animal feces from a select surface, the method comprising the steps of detecting the presence of animal feces on the select surface, using a sensor module; collecting the animal feces by automatically sucking detected animal feces rearwardly into a tube communicably coupled to a collector; and storing the animal feces sucked rearwardly into the tube, in a waste storage canister.

In accordance with the present disclosure, the method further includes the step of storing a freezing agent for solidifying the animal feces, in a second canister.

In accordance with the present disclosure, the method further includes the steps of capturing images of animal feces on the select surface, using a camera module; and displaying the images captured by the camera module, on a display module.

### BRIEF DESCRIPTION OF THE DRAWINGS

These and the other features, aspects, and advantages of the present invention will become apparent when the following detailed description is analyzed in conjunction with the accompanying drawings in which like characters represent like parts throughout, wherein:

FIG. 1 is a block diagram illustrating the functional components of the apparatus for collecting animal feces, in accordance with the present disclosure;

FIG. 2 is a block diagram illustrating the functional components of the apparatus for collecting animal feces, in accordance with the present disclosure;

FIG. 3 is a flow chat illustrating the steps involved in the method for collecting animal feces, in accordance with the present disclosure.

### DETAILED DESCRIPTION

The present disclosure envisages an apparatus for collecting animal feces from a select surface. The apparatus comprises at least one sensor module configured to detect the presence of animal feces on the select surface.

The apparatus, in accordance with the present disclosure further includes a collector configured to collect the animal feces, the collector comprising a tube having a suction mount attached thereto, the suction mount operable via a gas powered engine, the suction mount configured to suck the animal feces rearwardly into the tube. The apparatus in accordance with the present disclosure further comprises a waste capture canister configured to the tube via an L-shaped bracket, the waste capture canister configured to collect and store the animal feces sucked rearwardly into the tube.

The apparatus further includes a second canister configured to store a freezing agent for solidifying the animal feces. The apparatus further includes a camera module configured to capture images of animal feces on the select surface, the apparatus further comprising a display module communicably coupled to the camera module for displaying the images captured by the camera module.

The apparatus further includes a forward drive lever coupled to the gas powered engine, the forward drive lever configured to enable the apparatus to be pushed in a forward direction. The apparatus further includes a C-clamp having a plurality of grooves, the C-clamp configured to secure the waste capture canister to the tube. The apparatus in accordance with the present disclosure, wherein the tube includes a centrally disposed longitudinal axis, a proximal end and a distal end, wherein the proximal end is connected to the suction mount and the distal end is connected to the waste capture canister.

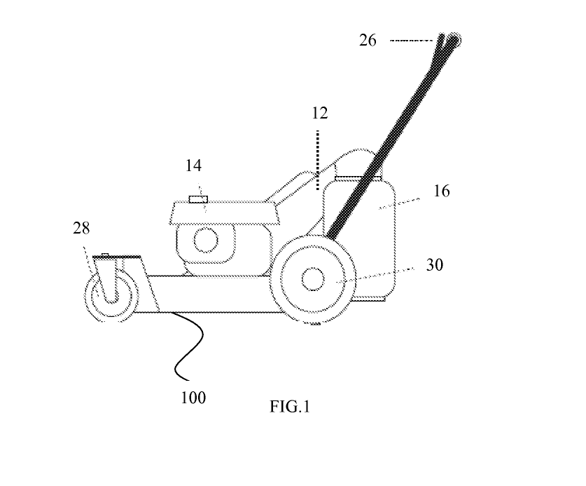

Referring to FIG. 1, there is shown an apparatus 100 for collecting animal feces from a select surface. The apparatus 100 comprises at least one sensor module (not shown in figures) configured to detect the presence of animal feces on the select surface.

The apparatus 100, in accordance with the present disclosure further includes a collector (not shown in figures) configured to collect the animal feces, the collector comprising a tube 12 having a suction mount (not shown in figures) attached thereto, the suction mount operable via a gas powered engine 14, the suction mount configured to suck the animal feces rearwardly into the tube 12. The apparatus 100 in accordance with the present disclosure further comprises a waste capture canister 16 configured to the tube 12 via an L-shaped bracket 18, the waste capture canister 16 configured to collect and store the animal feces sucked rearwardly into the tube 12.

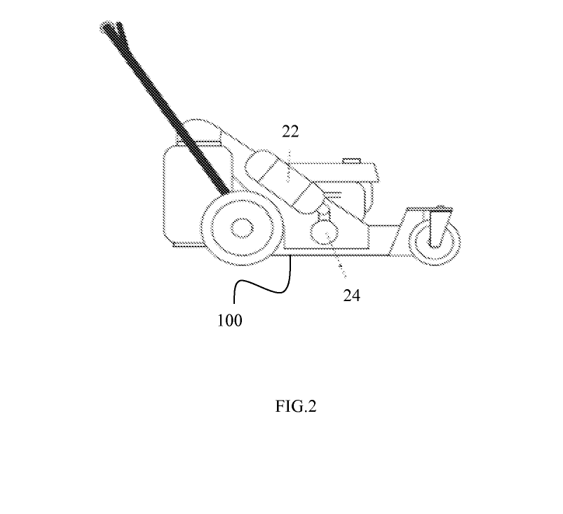

Referring to FIG. 2, the apparatus 100 further includes a second canister 22 configured to store a freezing agent for solidifying the animal feces. The freezing agent is sprayed on the animal feces, typically via a spray nozzle 24. The apparatus 100 further includes a camera module (not shown in figures) configured to capture images of animal feces on the select surface, the apparatus 100 further comprising a display module (not shown in figures) communicably coupled to the camera module for displaying the images captured by the camera module.

Referring again to FIG. 1, the apparatus 100 further includes a forward drive lever 26 coupled to the gas powered engine 14, the forward drive lever 26 configured to enable the apparatus 100 to be pushed in a forward direction. The apparatus 100 further includes a C-clamp (not shown in figures) having a plurality of grooves, the C-clamp configured to secure the waste capture canister 16 to the tube 12. The tube 12 includes a centrally disposed longitudinal axis, a proximal end and a distal end, wherein the proximal end is connected to the suction mount and the distal end is connected to the waste capture canister. The apparatus 100 is preferably mounted on a chassis having a solitary easy turn front wheel 28, and a pair of solid rear wheels 30.

The foregoing description of the specific embodiments will so fully reveal the general nature of the embodiments herein that others can, by applying current knowledge, readily modify and/or adapt for various applications such embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, those skilled in the art will recognize that the embodiments herein can be practiced with modifications.

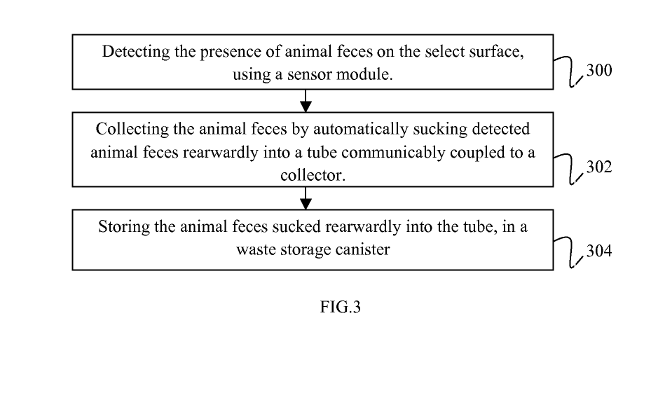

Referring to FIG. 3 there is shown a flow chart illustrating the steps involved in the method for collecting animal feces from a select surface. The method, in accordance with the present disclosure includes the following steps:

The present disclosure envisages a method for collecting animal feces from a select surface, the method comprising the steps of detecting the presence of animal feces on said select surface, using a sensor module (300); collecting the animal feces by automatically sucking detected animal feces rearwardly into a tube communicably coupled to a collector (302); and storing the animal feces sucked rearwardly into the tube, in a waste storage canister (304).

In accordance with the present disclosure, the method further includes the step of storing a freezing agent for solidifying the animal feces, in a second canister.

In accordance with the present disclosure, the method further includes the steps of capturing images of animal feces on the select surface, using a camera module; and displaying the images captured by the camera module, on a display module.

The technical advantages envisaged by the present disclosure include the realization of an apparatus that allows animal feces to be collected and disposed in a hygienic manner. The apparatus is easy to use and easy to maintain. The apparatus has been configured to automatically collect animal feces thereby eliminating a need for manual intervention. The apparatus envisaged by the present disclosure is capable of fast freezing wet feces for easy disposal, by providing for a storage tank that stores a freezing agent. Further, the animal feces collecting apparatus envisaged by the present disclosure is easy to clean. The waste storage canister envisaged by the present disclosure is easily replaceable.

What is claimed is:

1. An apparatus for collecting animal feces from a select surface, said apparatus comprising:
at least one sensor module configured to detect the presence of animal feces on said select surface;
a collector configured to collect the animal feces, said collector comprising a tube having a suction mount attached thereto, said suction mount operable via a gas powered engine, said suction mount configured to automatically suck detected animal feces rearwardly into the tube; and
a waste capture canister connected to said tube via an L-shaped bracket, said waste capture canister configured to collect and store the animal feces sucked rearwardly into the tube.

2. The apparatus as claimed in claim 1, wherein said apparatus further includes a second canister configured to store a freezing agent for solidifying the animal feces.

3. The apparatus as claimed in claim 1, wherein said apparatus further includes a camera module configured to capture images of animal feces on the select surface, said apparatus further comprising a display module communicably coupled to the camera module for displaying the images captured by the camera module.

4. The apparatus as claimed in claim 1, wherein said apparatus further includes a forward drive lever coupled to the gas powered engine, said forward drive lever configured to enable the apparatus to be pushed in a forward direction.

5. The apparatus as claimed in claim 1, wherein said apparatus further includes a C-clamp having a plurality of grooves, said C-clamp configured to secure the waste capture canister to the tube.

6. The apparatus as claimed in claim 1, wherein said tube includes a centrally disposed longitudinal axis, a proximal end and a distal end, wherein the proximal end is connected to the suction mount and the distal end is connected to the waste capture canister.

7. A method for collecting animal feces from a select surface, said method comprising the following steps:
detecting the presence of animal feces on said select surface, using a sensor module;
collecting the animal feces by automatically sucking detected animal feces rearwardly into a tube communicably coupled to a collector; and
storing the animal feces sucked rearwardly into the tube, in a waste storage canister.

8. The method as claimed in claim 7, wherein said method further includes the step of storing a freezing agent for solidifying the animal feces, in a second canister.

9. The method as claimed in claim 7, wherein said method further includes the following steps:
capturing images of animal feces on the select surface, using a camera module;
displaying the images captured by the camera module, on a display module.
